(19) United States
(12) Patent Application Publication
(10) Pub. No.: US 2025/0289202 A1
(43) Pub. Date: Sep. 18, 2025

(54) Model Based Roller Calibration Method

(71) Applicant: BW Converting, Inc., Green Bay, WI (US)

(72) Inventors: Jacob Liimatta, De Pere, WI (US); Cory Schubring, De Pere, WI (US)

(21) Appl. No.: 19/060,251

(22) Filed: Feb. 21, 2025

Related U.S. Application Data
(60) Provisional application No. 63/564,566, filed on Mar. 13, 2024.

(51) Int. Cl. B31F 1/07

(52) U.S. Cl. CPC B31F 1/07; B31F 2201/0753; B31F 2201/0776; B31F 2201/0779

(57) ABSTRACT

In a machine having a pressure and embossing roller, a position of an actuator operatively connected to a journal of the pressure roller is calibrated to a width of a nip formed between the pressure and the embossing rollers. The position of the actuator is changed to move the pressure roller to a position at which the nip forms between the pressure and the embossing rollers. The nip widths are measured in at least three locations along of the rollers. An interference between the pressure and the embossing rollers is calculated at each of the three locations. A deflection curvature of the pressure roller is calculated. A deflection of the journal of the pressure roller at the connection location to the actuator is calculated. The measured widths of the nip are correlated with the position of the actuator when the widths of the nip were measured.

### RELATED APPLICATION DATA

This application claims priority benefit to U.S. provisional application Ser. No. 63/564,566, filed Mar. 13, 2024, the disclosure of which is incorporated by reference herein.

### BACKGROUND

This disclosure is directed to methods and apparatus for embossing and/or laminating, and more particularly toward embossing and/or laminating for the production of bathroom tissue and kitchen towel. More in particular, the disclosure is directed to a process for calibrating a nip between a rubber roller (whether a marrying roller or pressure roller) and a steel embossing roller. Typically, the rubber roller is crowned and the embossing roller is a non-smooth, steel engraved roller. Once calibrated with a desired embossing nip width, the embossing and/or laminating operation may proceed for normal production. In another aspect, the disclosure is directed to a process for adjusting a nip between a rubber roller and a steel embossing roller.

It is well known in the art that an offset gravure process can be used for coating one or both sides of a web of tissue or towel product. It is well known in the art that laminating two or more plies of a tissue or towel product together amounts to embossing at least one of the plies, applying a coating of adhesive or water to the embossing protuberances formed on the embossed ply or plies, and then joining the ply or plies with one or more further plies to form a laminated product. The application of a coating of adhesive in an embosser-laminator can use essentially the same offset gravure process as a coater. U.S. Pat. No. 3,556,907 discloses an embossing-laminating device which is in many ways still representative of the current state of the art. U.S. Pat. No. 7,584,698 discloses an embossing-laminating device representative of the current state of the art, with an improvement over U.S. Pat. No. 3,556,907 being the open adhesive fountain and transfer rolls are replaced by an adhesive distributing assembly comprising an adhesive chamber (also known as a doctor chamber), a gravure roller (also known as an anilox roller), and an applicator roller (also known as a cliché roller).

Calibration of the process rollers in coating machines comprises setting the nip between the gravure and applicator rolls, and setting the gap between pairs of applicator rolls (in two-sided coating) or setting the gap between the applicator roller and a backing roller (in one-sided coating). Calibration of the gravure and applicator rolls in an embosser-laminator follows a similar process, except that a gap is set between the applicator roller and the embossing protuberances of an engraved embossing roller. Calibration of an embosser-laminator further comprises setting the nip(s) in one or more embossing nip stations each comprising a steel engraved roller and a pressure roller covered with an elastic material such as rubber. Calibrating the nip between a gravure roller and an applicator roller comprises (a) determining a reference point of the extent of the gap or nip engagement between the rolls, for example initial contact between the rolls (or “zero”), and (b) assuring that the extent of gap or nip engagement between the rolls is consistent across the width of the rolls. Calibrating the nip between the steel engraved roller and a pressure roller involves a similar process, but is complicated by the fact that the steel roller is engraved with a discontinuous pattern of embossing protuberances, and by the fact that the cover of the pressure roller is typically provided with a crowned profile. Calibrating the nip between a steel engraved roller and a pressure roller further comprises determining the width of the nip flat formed between the rolls, and correlating the width of the nip flat with a machine setting, for example, the positions of the actuators that move the pressure roller against the steel engraved roller. In the current state of the art, measuring a gap between rolls involves a person inserting a feeler gauge into the nip and making adjustments until the person subjectively judges that the feeler gauge fits, but only just fits, between the rolls, to a degree that is consistent across the width of the rolls. In the current state of the art, measuring a nip flat in an embossing station involves a person attaching nip impression paper (available from, for example, Valmet) to one of the rolls, loading the pressure roller against the steel engraved roller, unloading the rolls, removing the nip impression paper, drawing a line along each edge of the impression made on the nip impression paper based on their judgment of where the edges are, and measuring the distance between the lines.

Prior art methods and apparatus for calibrating process rolls are described in the patent literature. In U.S. Pat. No. 5,415,720, a stop is adjusted based on feedback from a distance sensor measuring the gap between an applicator roller and a fluted roller to set the gap to a setpoint. In U.S. Pat. No. 5,785,802, contact between a web and a roller is indicated by a change of speed of a roller. In U.S. Pat. No. 5,876,530, vibration, noise, drive torque, or reaction force indicates contact between rolls with paper disposed between the rolls. In U.S. Pat. No. 6,692,602, contact force between the rolls' bearing housings is measured, and the distance between the bearings is reduced until a decrease in the contact force between the bearing housings indicates that stop rings at the ends of the rolls have come into contact, which sets a known gap between the rolls. In U.S. Pat. No. 6,620,455, the force of the web in the nip is measured, and adjustments are made until the force reaches a setpoint. In EP 1362690A1, contact between a web and a roller is indicated by a change of speed of a roller.

### BRIEF DESCRIPTION OF THE DRAWINGS

FIG. 1 is a left side, top perspective view of a mainframe structure for a laminating and embossing unit with an adhesive deck adapted and configured to be moved into and out of connection with the mainframe structure to allow installation and removal of one or more rolls associated with the laminating and embossing unit.

FIG. 2 is an elevation view of an exemplary actuator and journal of a roller, which may a rubber roller and/or a steel roller.

FIG. 3A shows a beginning of a process flow for an exemplary process for roller calibration.

FIG. 3B shows the continuation of the process flow from FIG. 3A.

FIG. 3C shows an example of a nip width impression taken with carbon paper.

FIG. 3D shows measurement of the nip width impression of FIG. 3C with a scale.

FIG. 4A shows a beginning of a process flow for an exemplary process for setting a desired nip width.

FIG. 4B shows the continuation of the process flow from FIG. 4A.

FIG. 5 is a schematic representation of a bending model for estimating the deflection of a rubber roller.

FIG. 6 is a schematic representation of a contact stress model for estimating the deflection of a rubber roller when loaded with a steel roller.

FIG. 7 is a schematic representation of a deflection of a rubber roller when loaded with a steel roller and in particular shows the linear interference and nip flat width.

FIG. 8A shows a beginning of a process flow for an automatic or semi-automatic nip width measurement process.

FIG. 8B shows the continuation of the process flow from FIG. 8A.

FIG. 9 is a process flow for calibrating the output in pixels of FIGS. 8A-B with a physical nip width measurement.

FIG. 10 is a process flow for an automatic or semi-automatic nip flat calibration process.

FIG. 11 is a process flow for calculating a linear interference adjustment needed to achieve a uniform nip flat.

FIG. 12A is a process flow to characterize the behavior of the rollers given variable linear interference.

FIG. 12B shows the continuation of the process flow from FIG. 12A.

FIG. 13 is a chart showing actuator positions and the corresponding nip flat width calculations based on the process flows of FIGS. 8A-B, 9-11, 12A-B and 13.

FIG. 14 shows an example of a nip width image generated by image capture devices associated with a vision system and a measurement of the nip width image by the vision system.

### DETAILED DESCRIPTION

As will become evident from the discussion that follows, the methods and apparatus described herein provide for improved safety, precision, and repeatability in calibrating the distance between a rubber roller and steel roller, without additional complexity or cost. Accordingly, the disclosure is directed to eliminating subjectivity in the calibration of rubber rollers and steel roller combinations, that is, whether pressure roller or marrying roller combinations typically found in an embosser, a laminator and/or combination embosser-laminator, by automating the process and removing operator judgement from the process.

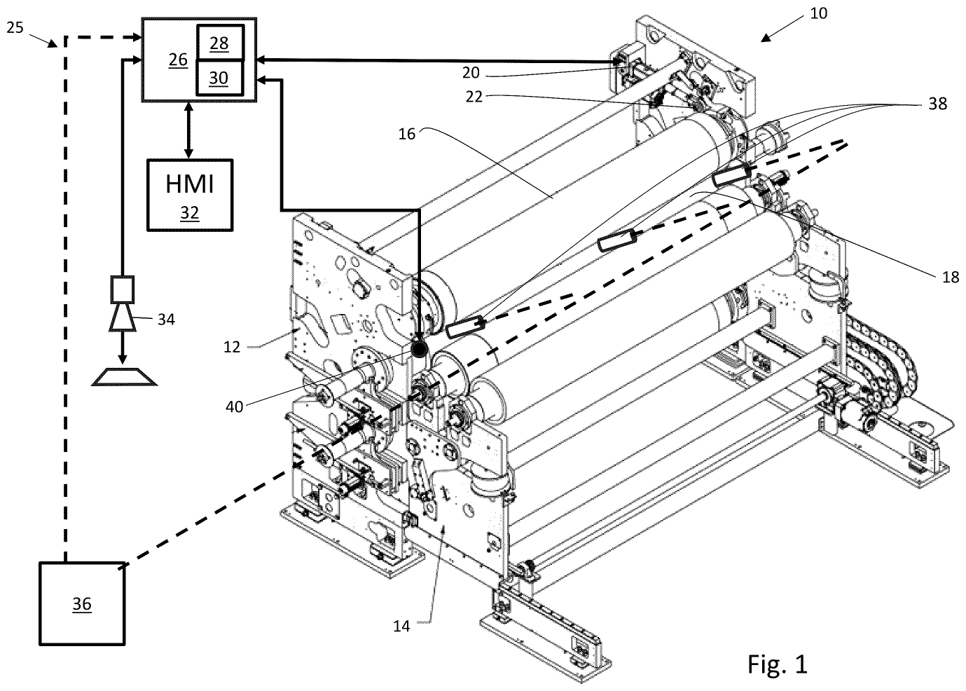

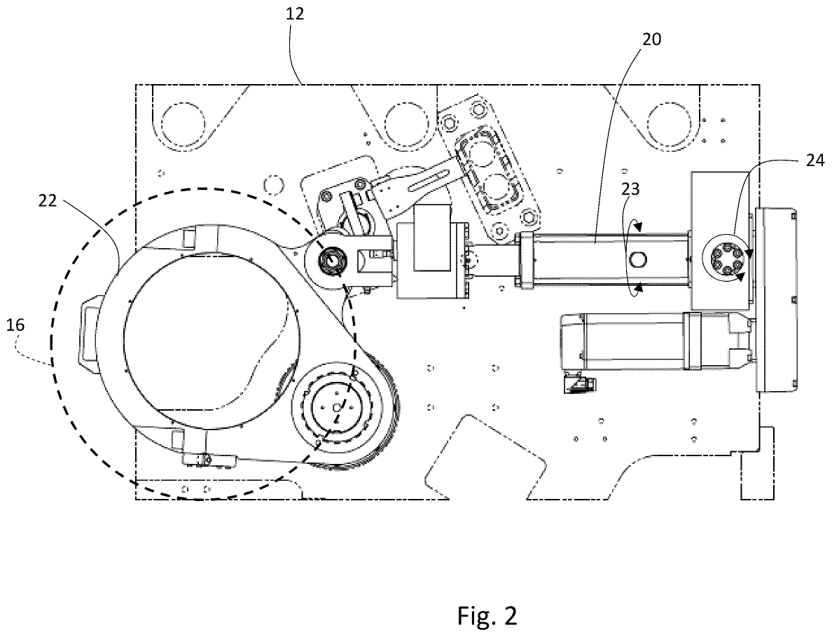

By way of example, FIG. 1 shows a mainframe structure 10 of a machine with a portion 12 that houses an embossing laminating unit and a portion with a subframe 14 that houses an adhesive deck. An actuator may be provided on respective sides of the mainframe structure 10 adjacent the journals and bearings of the rollers and may be configured to adjust the distance between the rubber roll 16 and the steel embossing roll 18. By way of example, FIG. 2 shows an exemplary representation of an actuator 20 that may be adjusted to adjust the location of a journal 22 of a roller. The portion 12 of the mainframe structure 10 may have the actuator on opposite axial ends of the steel roller(s) and may have the actuator on opposite axial ends of the rubber roller(s). The actuators may include a servo linear actuators, or a pneumatic actuator with a mechanical stop, such as a Firestone model W01-358-6952, or an electric motor driven actuator with a ball or acme leadscrew. The servo actuator 20 is mounted to the mainframe structure 10 of the machine with degrees of freedom in two rotational directions 23,24 to allow for misalignment of the actuator 20 and thereby extend the life of the pressure roller loading system.

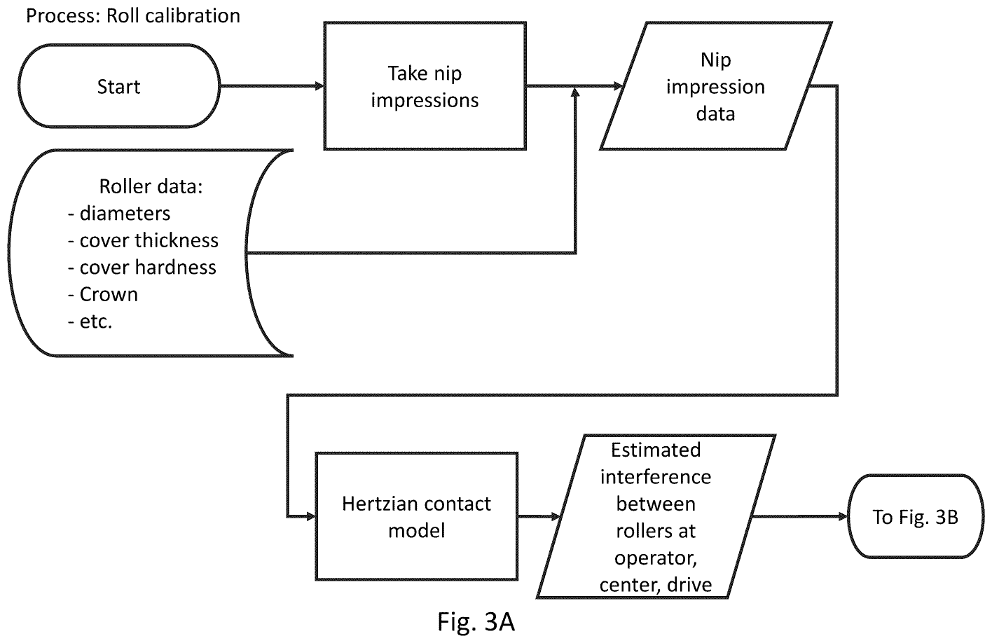

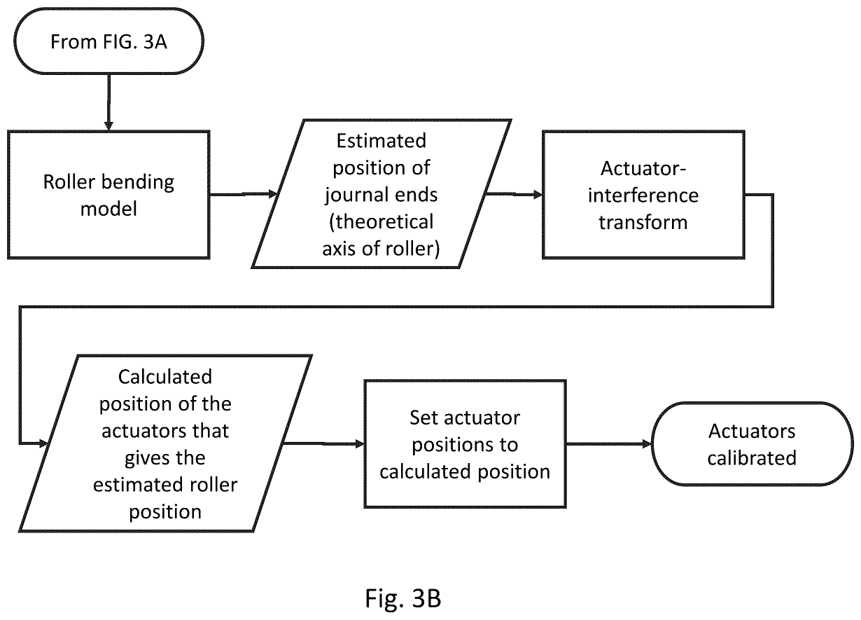

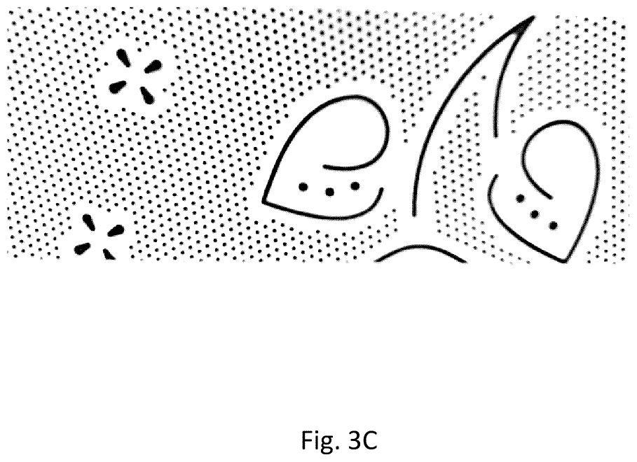

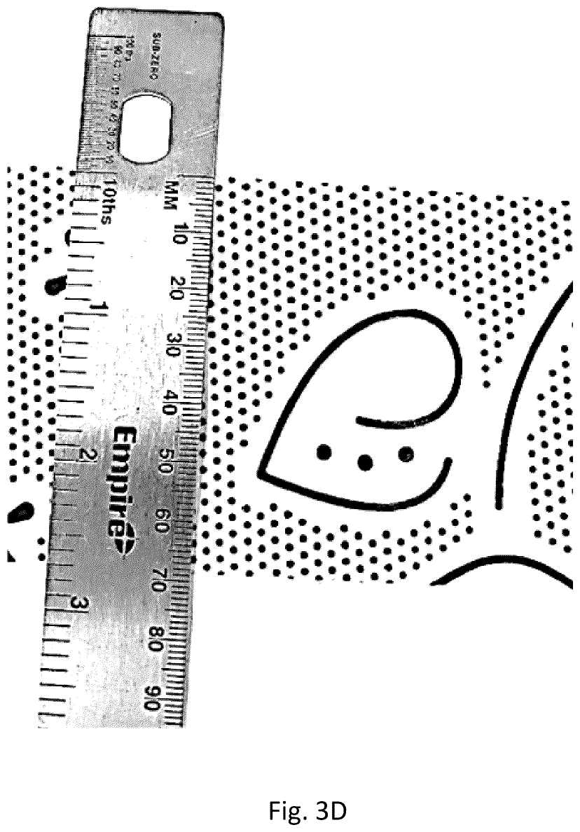

A control 25 for the machine may have a controller 26 with a processor 28 and memory 30 may be interfaced with machine, and more in particular, the actuators 20 of the portion 12 of the mainframe structure 10 to provide control signals to position the actuators and the locations of the journals 22 of the respective rollers 16,18. As will become evident from the discussion that follows, the memory 30 of the controller 26 may have stored instructions that when executed by the process 28, perform the functions described in the process flows of FIGS. 3A-B, 4A-B, 5-7, 8A-B, 9-11, 12A-B and 13.

FIGS. 3A-B, 4A-B, 5-7, 8A-B, 9-11, 12A-B and 13 illustrate aspects of methods that may be employed to calibrate the rollers including setting the nip width. Based on a nip impression, a mathematical transform may be used to relate nip flat width to rubber roller actuator position for the purpose of calibrating the actuators to a known position to begin normal operation of the embosser/laminator. The mathematical transform may incorporate a modified Hertzian contact model (a nip flat model), a bending model of the roller, and a kinematic actuator-interference transform to calculate the expected actuator position for a given set of nip impression measurements. Conventional Hertzian contact theory assumes both bodies are elastic with similar material properties and small strains. In the case of a steel embossing roller and a rubber covered pressure roller, there is a significant difference in material stiffness and the contact nip flat width is significant relative to the pressure roller cover thickness. For these reasons, a modified Hertzian approach may be needed to relate contact forces and resultant nip widths. Modifications are required to accommodate features including, but not limited to, a large ratio of nip width to roller diameter, non-linear elastic behavior, temperature effects, and embossing roller surface pattern. These considerations are well understood in the art. The model can be modified based on a balance of required resolution and computational complexity. One example of a well-known modification to conventional Hertzian contact equations is discussed by Narayan V. Deshpande, “Calculation of Nip Width Between Elastomeric Cylinders,” Tappi Journal, Vol 61, no 10, pg. 115-118, October 1978.

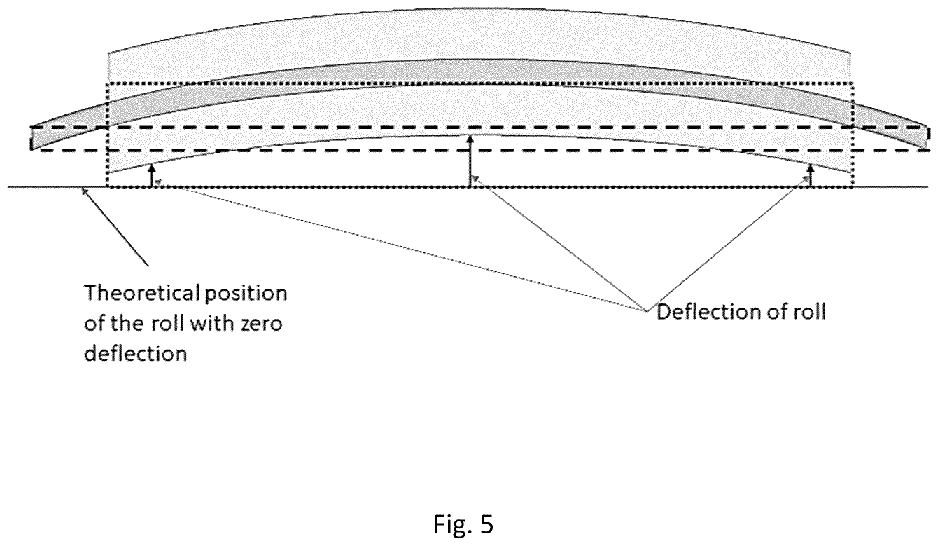

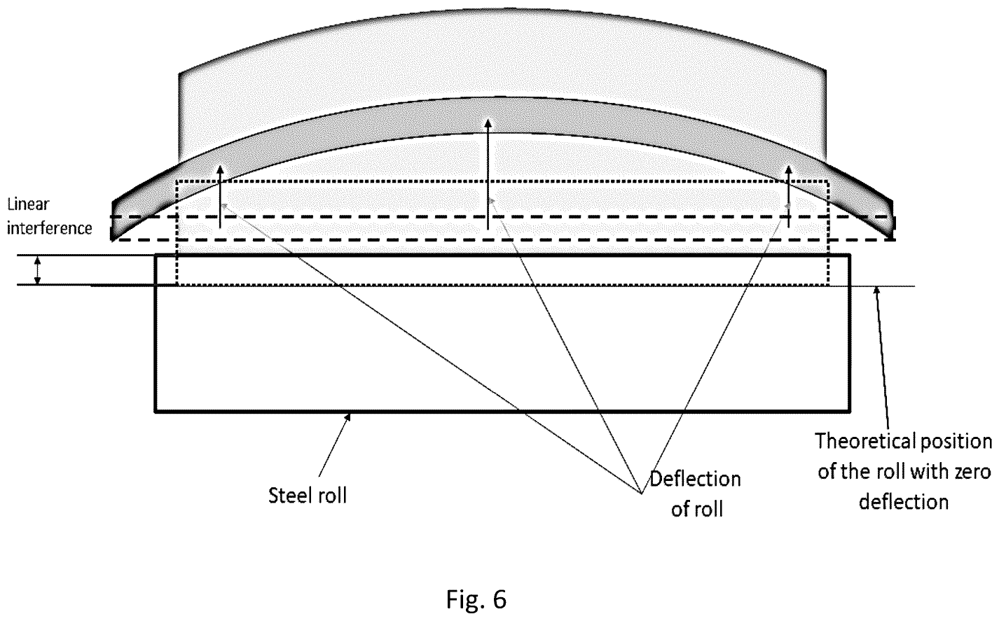

Making reference to FIGS. 3A-B, the operator may obtain nip impressions at the operator side, drive side and the center of the roller set, and input the measured impression data to the controller 26 manually via an interface 34 of the machine. The operator may tape or adhere carbon paper to the steel roller in a specific position to acquire the nip impression. FIG. 3C is an example of a nip width impression taken with carbon paper. FIG. 3D is an example of measuring the width of a nip with a scale. Roller data, for example, steel roller nominal outside diameter, steel roller inside diameter, steel roller material modulus, steel roller face width; rubber roller nominal outside diameter, rubber roller inside diameter, rubber roller core material modulus, rubber roller face width, rubber roller rubber cover thickness, rubber roller rubber cover crown, rubber roller rubber cover hardness, and, rubber roller core modulus, may be used as data inputs to the controller 26 for calculations involving the bending model of the rubber roller and/or the modified Hertzian contact model and later for the roller bending model. In one aspect, three measurements may be made: one at each of the operator side, the center, and the drive side of the rubber roller. Based on the nip impression widths, the roller data, for instance, the roller geometric parameters, and rubber roller rubber characteristics, the controller 28 is enabled with instructions to construct and execute a modified Hertzian contact model to calculate the actual interference present between the rubber and steel rollers at the specific location along the width of the roller corresponding to location of the sampled impression. Representations of rubber roller deflection and contact causing linear interference with the steel roller are shown in FIGS. 5-7. The controller 26 may be further enabled to calculate the interference between the rollers at the operator, center, and drive side locations, and then subtract the mean of the operator and drive side interferences from the center interference to provide the relative position of the center with respect to the edges of the roller. The controller 26 may be enabled to determine the curvature of the roller and then fit the roller curvature to the three known interference results to calculate the overall magnitude of the roller deflection at the operator and drive side measurement locations. Using the determined curvature of the roller, the controller may be further enabled to calculate a theoretical interference of the rollers and determine the location of the roller journals. The controller may be further enabled to transform the location and/or position of the journals, or the theoretical position of the roller, to the actuator position, using a theoretical tangential contact between the rollers as the zero position. The controller may then be enabled to send a signal to position the actuators so the actuators are calibrated to the computed position, at which point, calibration of the roller is complete.

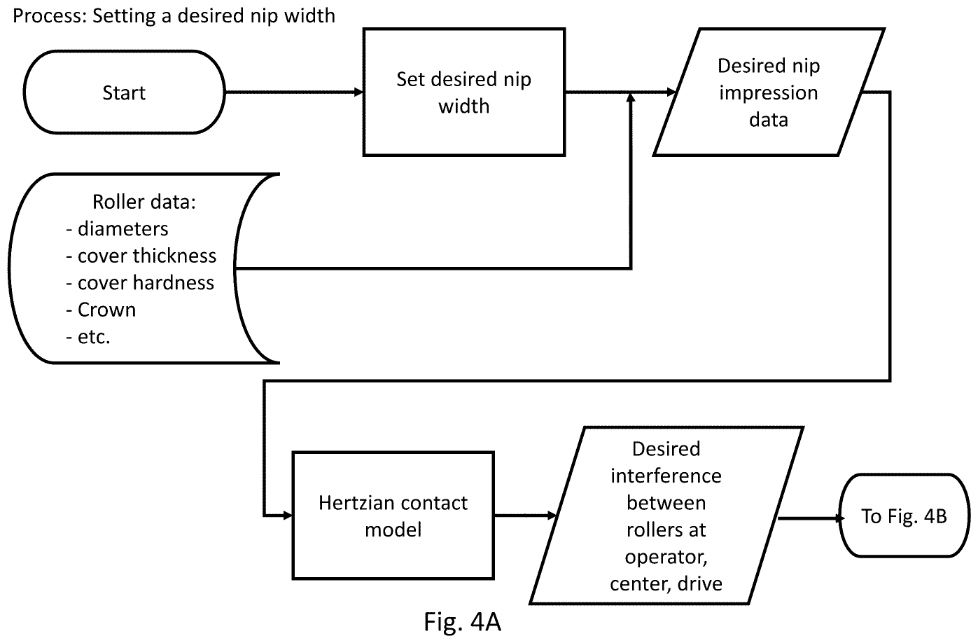

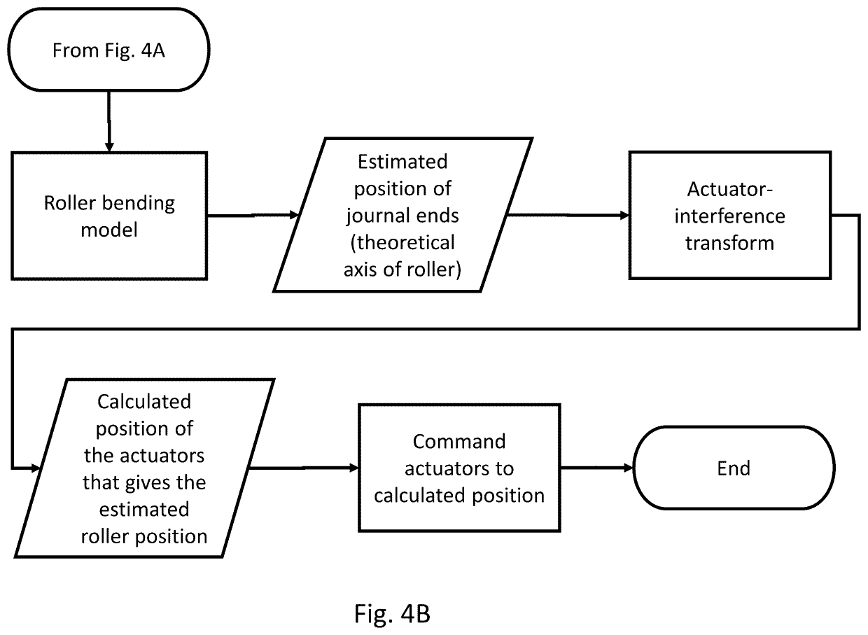

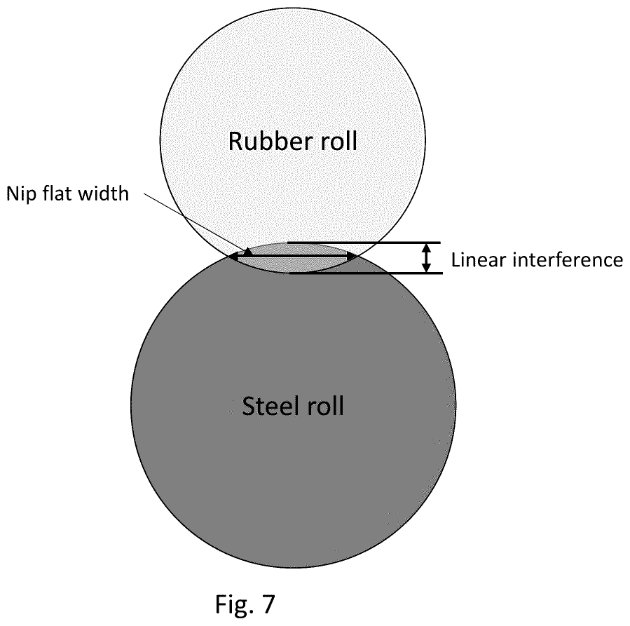

As shown in FIGS. 4A-B, after an initial roller position calibration, the operator may set a desired nip flat width for the roller set. FIG. 7 illustrates the nip flat width. The controller may be enabled to conduct a process that mirrors the roller calibration process discussed above, and may be enabled to use a similar contact model and bending model to estimate the required position for the desired nip flat width. The controller may be further enabled to calculate the position of the actuators for the desired nip flat width using the same transform.

As mentioned above, to initiate the roller calibration process, the operator is required to perform a nip impression at the operator, center, and drives sides of the roller set. The roller set must be loaded to some level of interference, ideally in the operating regime of the rollers, for example, to set a nip flat width in the range of around 30 to 50 mm for a nip between the steel engraved roller and the pressure roller. As shown in the process flow of FIGS. 3A-B, the impressions may be measured manually and input by the operator into the controller 26 via the interface 32 so as to allow the controller of the machine to perform the calibration process.

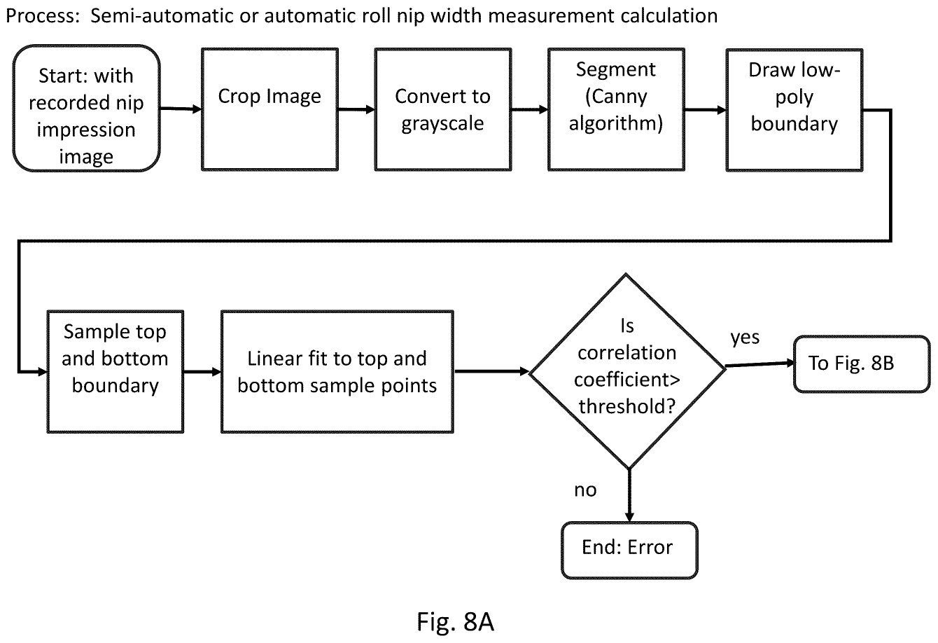

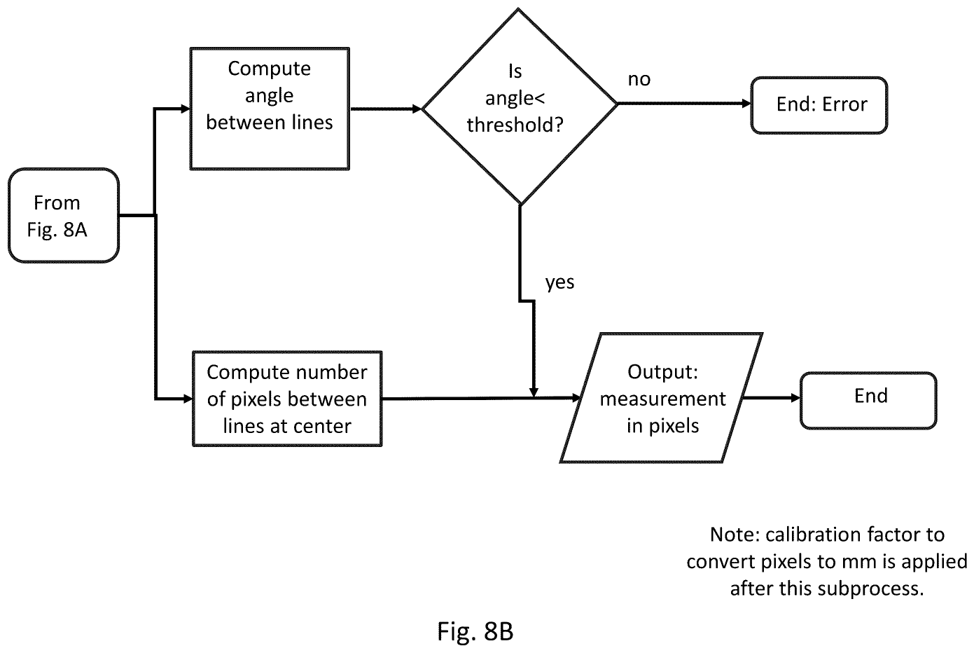

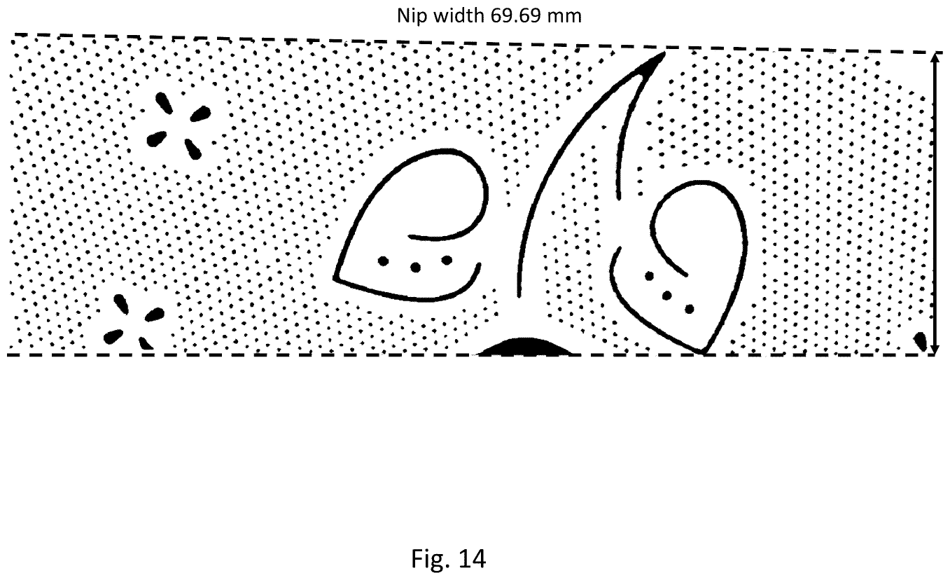

Alternatively, the measurement of the nip widths from the impressions may be performed by semi-automatic or fully-automatic means, for instance, as illustrated in FIGS. 8A-8B, 9-11, 12A-B, and 13-14. As with the manual operation, in a semi-automatic or automatic implementation, the operator may first tape or adhere the carbon paper to the steel roller in a specific position to acquire the nip impressions. In a semi-automatic implementation, an optical measurement system 34 near the embosser and/or laminator may be used to measure the width of the nip impressions that were manually taken by the operator as described above. The operator may remove the nip impressions from the machine and deliver them to the optical measurement system 34 located near to the machine for processing and measurement of the nip width. Data representative of the impressions from optical measurement system 34 may be input by the operator into the controller 26 via interface 32, or the optical measurement system 34 may transmit them to the controller 26 of the embosser/laminator automatically. In an alternative embodiment, which is an a fully-automatic implementation, a vision system 36 with image acquisition devices 38, for instance, CCD, cameras, etc, that are located inside the embosser/laminator may measure the nip impressions while they remain on the steel roller 18, and the impression data may be transmitted to the controller 26 upon acquisition of the images. Three or more cameras 38 may be mounted in proximity to each of the two steel rollers 18 and enabled to capture the width of nip impressions automatically. The operator may engage the calibration mode, such that when the steel roller is rotated, the nip is loaded and the impression is created. The steel roller may then be rotated in a position to present the impressions to the camera for acquisition, and later analysis and measurement of the nip width. FIG. 14 is an example of a nip width image generated by image capture devices associated with the vision system 36. FIG. 14 also shows an example of a nip width measurement produced by the vision system 36. Additionally, measurements of the nip width may be made directly with a system such as the countroll NIP system. This system has historically not been applicable to engraved/pattern steel rolls due to force concentration of the elements, but direct measurement of the nip flat width via a sensor may be realized. A technology such as Valmet iRoll nip measurement system may also be used to measure nip width directly.

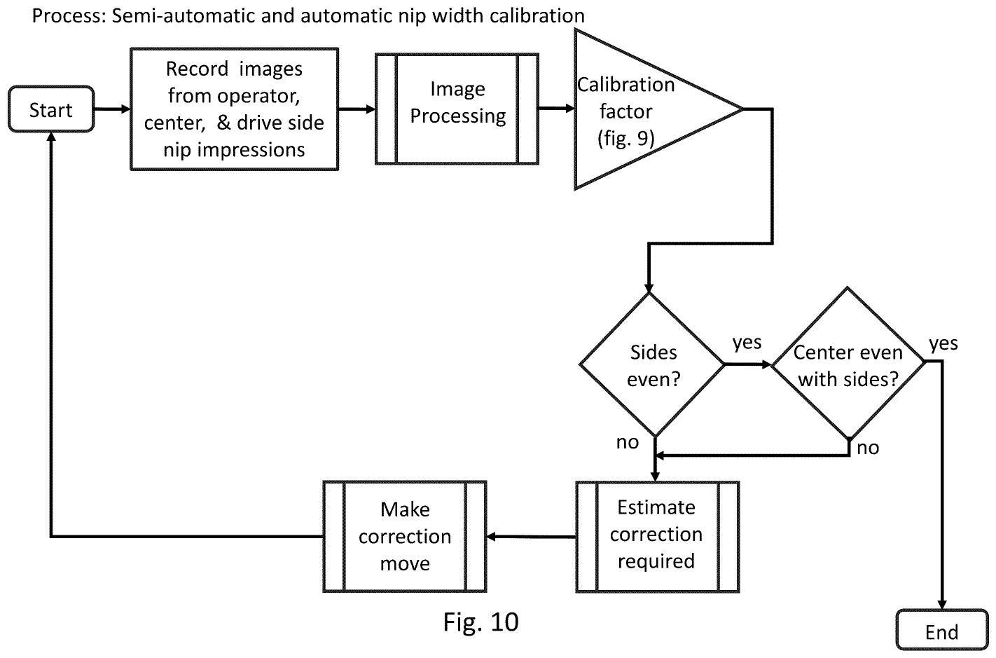

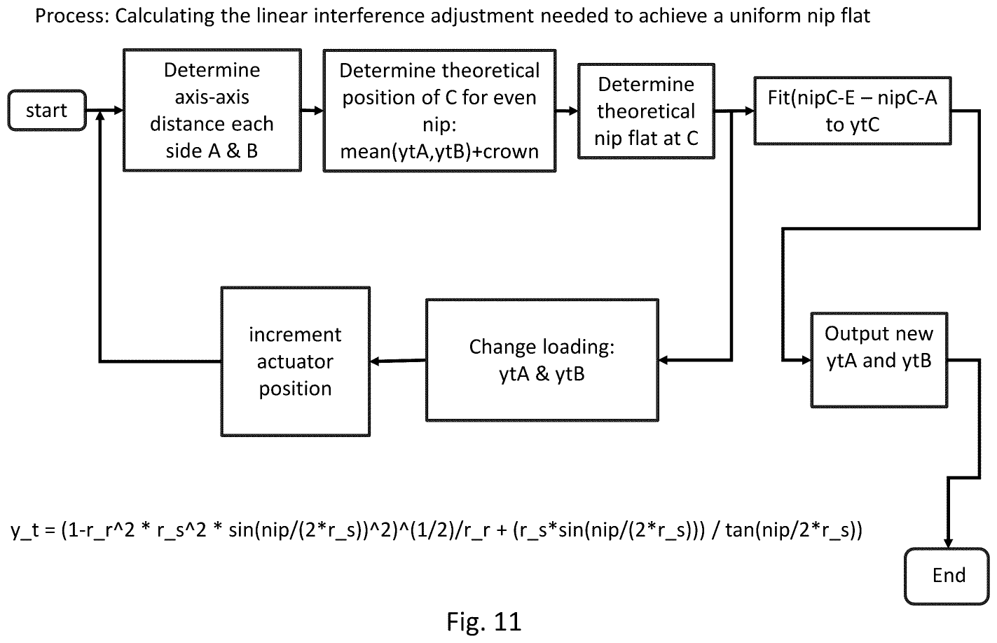

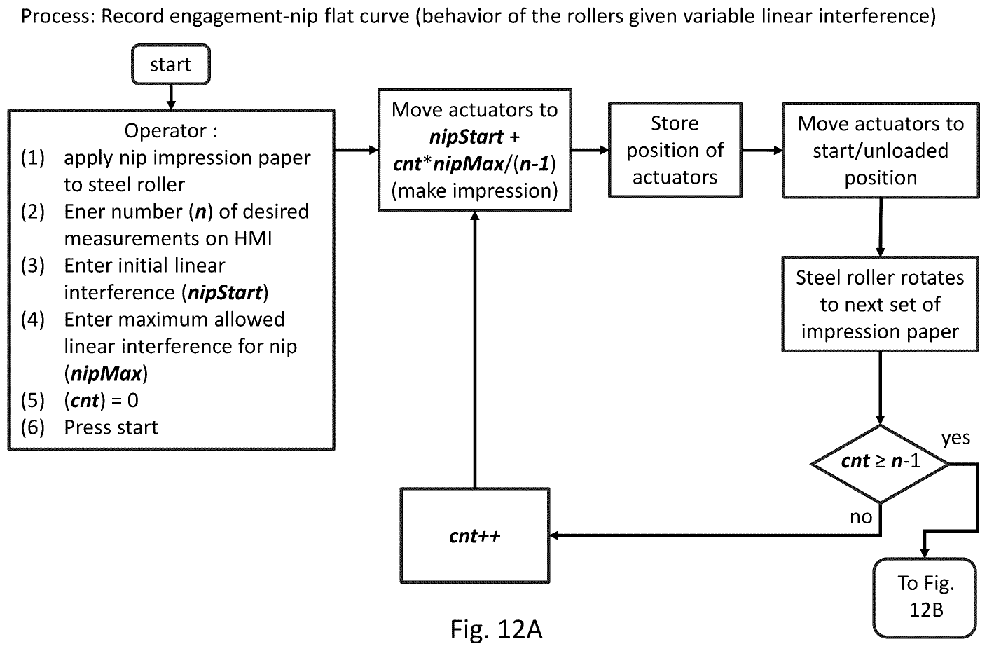

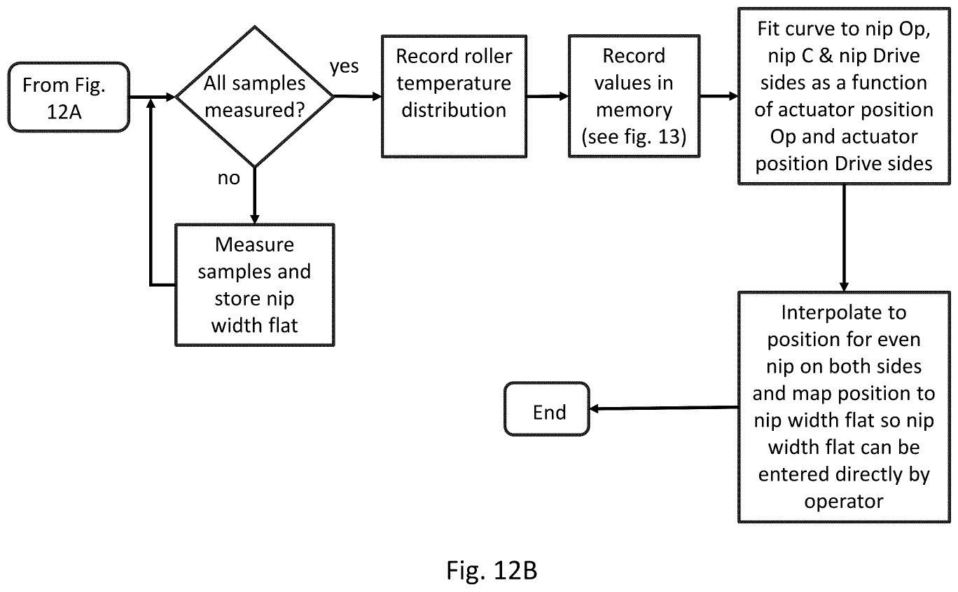

FIGS. 8A-B, and 9 describe processes of automatic or semi-automatic nip width measurement using data from a nip impression measurement system, for instance, an optical measurement system 34, a vision system 36, or a nip width direct measurement system (countrollNIP system. Valmet iRoll). FIG. 10 shows a process flow for setting drive and operator side actuators for the pressure roll so the nip width is consistent from one end of the roller to the opposite axial end. FIGS. 11 and 12A-B are process flows illustrating an algorithm for automatically characterizing a nip flat width from the nip impression data.

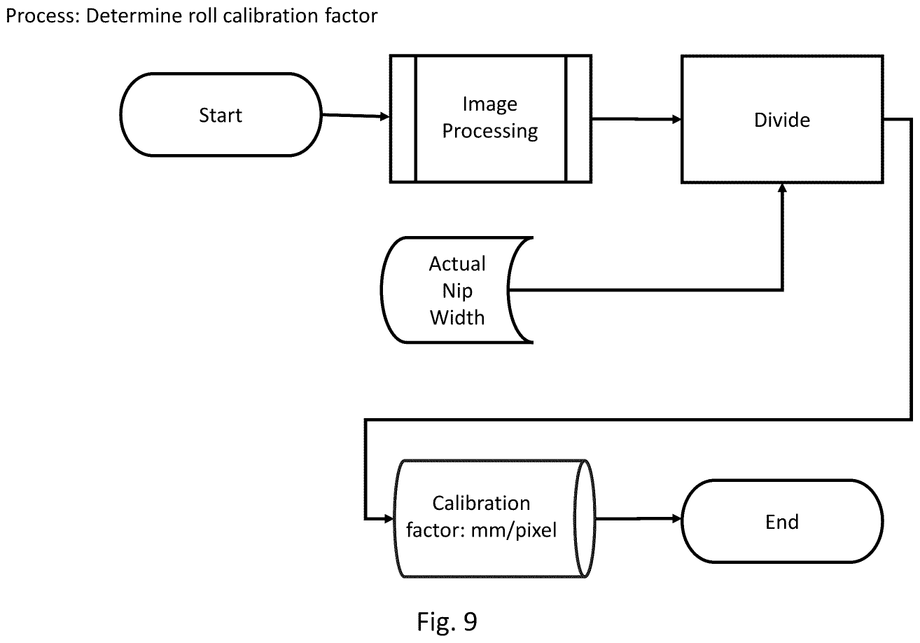

Referring to FIGS. 8A-B, once the nip impression images are recorded, the controller may be enabled to measure the nip widths by first processing the acquired image by cropping the image, converting the image to grayscale, and segmenting the recorded image to embolden the embossed areas. The segmenting step may include employing a Canny edge detection algorithm. The controller may be enabled to measure the segments by constructing or drawing a polygonal boundary around the embossings, and then fitting lines to the top and bottom of the boundary. As shown in FIG. 8B, the controller may be enabled to compute the number of pixels between the fitted lines at the centers of the fitted lines and compute an angle between the fitted lines so as to generate a measurement of the nip width in pixels. As shown in FIG. 9, the controller may be enabled to convert the output measurement nip width in pixels to a physical distance, for instance, millimeters, so as to generate a nip width measurement. The actual nip width input in FIG. 9 is a one-time physical measurement of a nip width that may be performed at initial commissioning of the image capture system.

As shown in FIG. 10, the nip width data may be used to assess actuator position so the nip flat may be even across the length of the rollers. The relation between nip flat width and actuator position also facilitates creating an even nip flat across the length of the rollers in the machine cross-wise direction automatically. The processes of FIGS. 8A-B and 9 may be repeated for each of the operator, center, and drive sides of the roller. If the operator side nip width, center nip width, and drive side nip width are not even with each other within a desired tolerance, the processor 28 may estimate a correction move for at least one of the actuators 20, and the controller 26 may provide a control signal to at least one of the actuators 20 according to the estimated correction move. The processes of FIGS. 8A-B and 9 may then be repeated until the operator side nip width, center nip width, and drive side nip width are even with each other. If the model resolution is sufficient, it should only take one iteration to achieve a uniform nip.

FIG. 11 illustrates a method for calculating the linear interference adjustment needed to achieve a uniform nip flat within the system. This method can serve two purposes: it can determine the appropriate interference settings to achieve a desired nip flat width, or conversely, it can predict whether a given combination of interference settings and nip flat width will result in non-uniform nip conditions due to roll bending and crown mismatch effects. For optimal embossing performance, it is generally accepted that the nip flat measurements at three key positions (operator side, drive side, and center) are ideally within 5-7% of each other. This uniformity helps ensure the embossed sheet maintains consistent caliper (thickness) across its width. However, in certain situations, it may be desirable to intentionally adjust the embosser loading to compensate for variations in the incoming web. One possible example is cross-direction caliper differences in the incoming web. The method described above can be adapted to provide an intuitive way to optimize the existing embossing system to minimize the variation in the web after the embossing process.

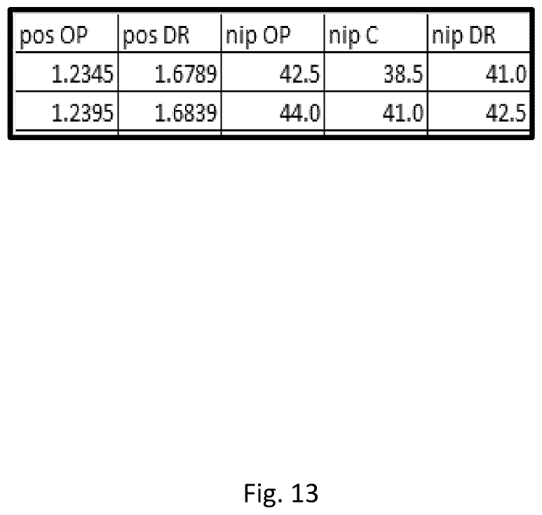

FIGS. 12A-B illustrate an exemplary process to characterize the behavior of the rollers given variable linear interference, and consequently actuator positions. Ideally, the supplied system would have well defined physical characteristics known based on the underlying engineering data, but there may be instances where, for example, a rubber cover compound is not well characterized. In a situation such as this, it may be beneficial to empirically characterize the system behavior and then apply the acquired information to the discussed model. FIG. 12A has a precondition that the actuators have already been referenced to the zero position at their tangential contact points. After this, the rolls can be set with varying amounts of linear interference, and the associated contact widths recorded for each interference at each roll position (pos OP, pos DR, pos C). With this information, the rubber can be characterized empirically. In one implementation, the rubber can be characterized by four (n=4) levels of linear interference. Four levels of interference may be both (a) a sufficient number of data points to characterize the rubber with a nip flat curve, and (b) provide an intuitive way for the operator to apply the nip paper to the steel roll, since n=4 results in nip paper being applied at 90 degree intervals around the steel embossing roll. Given three positions at the operator side, drive side, and center (pos OP, pos DR, pos C) and n=4 levels of interference, the operator would apply a total of twelve pieces of nip impression paper to the steel embossing roll. The operator may then enter an initial linear interference, a maximum linear interference, and the number of levels (n) of interference into the machine HMI. Once the operator initiates the process, the machine moves the actuators to the first level of linear interference, stores the position of the actuators, moves the actuators to the unloaded position, and rotates the steel roll (90 degrees in this example) and repeats that sequence for the remaining levels of linear interference (three levels, in this example, at equal intervals up to the maximum level). After nip impressions have been produced in the nip impression paper at all n levels of linear interference, the process moves on to FIG. 12B, in which the nip impressions are measured, the roller temperature distribution is recorded (the use of temperature data is described in more detail below), and the function of nip width to actuator position is determined for the operator side, center, and drive side positions. The data may be recorded in the memory of the controller of the control system, for example in a table as in FIG. 13. The combination of either pre-defined pressure roller rubber compound characteristics, or empirically defined characteristics determined above can then be used to directly estimate a desired roller linear interference given an operator entry of desired average nip flat width as shown in FIGS. 4A-B.

Accordingly, the control 25 for the machine may include the controller 26 having the processor 28 and the memory 30, which may be configured and enabled with program instructions to perform any one or more of the following: (i) a roller bending model; (ii) a modified Hertzian contact model; (iii) a rubber hardness to modulus transform; (iv) actuator-interference transform; and/or (v) an optical nip impression measurement. The controller may be configured so that one or more of the roller bending model, the modified Hertzian contact model and/or the rubber hardness modulus transform may use a numerical solving method such as a Newton-Raphson method to solve for the curvature of the rollers, given inputs of the roller geometric parameters, rubber type, crown, and load (Newtons per millimeter (N/mm) or pounds per linear inch (PLI)). Alternatively, the processor 28 and the memory 30 of the controller 26 may be enabled to estimate nip load based upon nip width. The controller 26 may then be configured to solve for actuator 20 position by increasing each actuator's loading until the bending profile of the rollers matches the expected value. The controller 26 may also be configured to differentiate between upper and lower rollers based upon the effects of the marrying roller on the steel roller curvature.

To further facilitate operator interaction with the control 25, the controller 26 may also be configured to store a plurality of data structures in the memory 30 of the controller that are representative of any one or more of the following associated with:
(a) the embossing roller:
   (i) embossing roller outside diameter;
   (ii) embossing roller inside diameter;
   (iii) embossing roller material modulus,
   (iv) embossing roller face width; and/or
   (v) embossing roller distance between bearing centerlines,
      and
(b) the pressure roller
   (i) pressure roller core outside diameter,
   (ii). pressure roller core inside diameter,
   (iii) pressure roller core material modulus,
   (iv) pressure roller face width,
   (v) pressure roller distance between bearing centerlines
   (vi) pressure roller cover thickness,
   (vii) pressure roller cover crown, and/or
   (viii) at least one of pressure roller cover hardness and pressure roller cover modulus.

The controller 26 may also be configured to store a plurality of data structures in the memory 30 of the controller that are representative of an embossing pattern, for example embossing element top area, element height, embossing pattern surface coverage, and/or element perimeter per unit area. This information could be used to augment the modified Hertzian contact model.

The controller 26 may be configured with programming that enables the generation of signals that may be transmitted between the controller 26 and other elements of the control 25, including actuation signals and sensor signals associated with the rollers 16,18 of the embossing/laminator. For instance, the controller 26 may be configured with programming that enables the generation and transmission of signals for changing the position of one or more actuators 20 that moves the pressure roller 16 to a position at which there is a nip between the pressure roller 16 and the embossing roller 18. For instance, the controller may be configured with programming to receive sensor signals, for instance, from the optical measurement system 34 or vision system 36, for measuring the widths of the nip between the pressure roller and the embossing roller in at least three locations in a direction along the axes of the rollers 16,18. One of the locations may be near the centerline of the rollers, and two of the locations may be approximately equidistant from the centerline of the rollers in opposite directions. The controller 26 may be configured to store as a plurality of data structures in addition to other data mentioned above, the measured widths of the nip.

The controller 26 may also be configured with programming to: (i) calculate an interference between the pressure roller 16 and the embossing roller 18 at each of the three locations, (ii) calculate a deflection curvature of the pressure roller, (iii) calculate a deflection of the journal of the pressure roller at the location of operative connection to the at least one actuator, (iv) associate or correlate, in the memory of the controller of the control system, the deflection of the journal of the pressure roller at the location of operative connection to the actuator with the position of the actuator, and (v) associate or correlate, in the memory of the controller of the control system, the measured widths of the nip with the position of the actuator when the widths of the nip were measured.

The actuator 20 for any one or each of the rollers may be a servo-linear actuator. So, the controller 26 may be configured to generate and transmit signals appropriate for actuation of such a servo-linear actuator. The actuators may be configured to provide direct measurement of the force applied by the actuators.

As mentioned earlier, the step of measuring the widths of the nip may involve an operator manually measuring the widths of the nip, and entering the measured widths of the nip into an interface or HMI 32 of the control 25, so as to store the measured widths of the nips as a plurality of data structures in the memory of the controller of the control system. Alternatively, the step of measuring the widths of the nip may involve measuring the widths of the nip with the optical measurement system 34 or the vision system 36, and having the vision system interfaced with the controller 26 so as to allow the measured widths of the nip to be semi-automatically (e.g., via operator approval) or automatically stored in the memory of the controller of the control system.

The calculation of the deflection curvature of the rubber roller may comprise calculating a relative deflection between the location near the centerline of the rubber roller 18 and the locations approximately equidistant from the centerline of the rubber roller. Sensor signals may sense such relative deflection and generate signals received by the controller to process the sensor signals and determine an amount of such deflection.

The calculation of rubber roller cover modulus may be based upon known values of the rubber roller cover hardness. Rubber roller cover modulus data may be obtained from manufacturers of rubber rollers. Force feedback from the actuators 20 may be used to calculate the modulus of the rubber cover.

Sensors 40 may sense the surface temperature of the rubber roller 18 and generate signals received by the controller 26 to process the sensor signals and store the surface temperature readings in the memory 30 for use in further processing, for instance, to adjust the widths of the nip between the pressure roller 16 and the embossing roller 18 during processing due to changes in temperature, changes in rubber roller cover modulus due to temperature, torque, and/or speed, or other effects on the rubber as the case may be.

Accordingly, the methods described herein allow for adjusting of the widths of a nip flat between the rubber roller 18 and the embossing roller 16. The methods described herein also allow for calibrating the position of the actuator 20 operatively connected to the journal 22 of the rubber roller to the width of the nip flat between the rubber roller and the embossing roller.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

1. A method of calibrating a position of an actuator to a width of a nip, wherein the nip is between a pressure roller and an embossing roller of a machine, and wherein the actuator is operatively connected to a journal of the pressure roller, the method comprising the steps of:
a. storing a plurality of data structures in a memory of a controller of a control system, the data structures comprising data representative of:
i. embossing roller outside diameter
ii. embossing roller inside diameter
iii. embossing roller material modulus,
iv. embossing roller face width, and
v. embossing roller distance between bearing centerlines,
b. storing a plurality of data structures in the memory of the controller of the control system, the data structures comprising data representative of:
i. pressure roller core outside diameter,
ii. pressure roller core inside diameter,
iii. pressure roller core material modulus,
iv. pressure roller face width,
v. pressure roller distance between bearing centerlines;
vi. pressure roller cover thickness,
vii. pressure roller cover crown, and
viii. at least one of pressure roller cover hardness and pressure roller cover modulus,
c. changing the position of the actuator to move the pressure roller to a position at which the nip is created between the pressure roller and the embossing roller,
d. measuring the widths of the nip between the pressure roller and the embossing roller in at least three locations in a direction along axes of the rollers, wherein one of the locations is near the centerline of the rollers, and wherein two of the locations are approximately equidistant from the centerline of the rollers in opposite directions,
e. storing a plurality of data structures comprising the measured widths of the nip in the memory of the controller of the control system,
f. calculating an interference between the pressure roller and the embossing roller at each of the three locations,
g. calculating a deflection curvature of the pressure roller,
h. calculating a deflection of the journal of the pressure roller at a location of operative connection to the actuator,
i. associating, in the memory of the controller of the control system, the deflection of the journal of the pressure roller at the location of operative connection to the actuator with the position of the actuator, and
j. associating, in the memory of the controller of the control system, the measured widths of the nip with the position of the actuator when the widths of the nip were measured.

2. The method of claim 1 wherein the actuator is a servo-linear actuator.

3. The method of claim 1 wherein a further actuator is operatively connected to a further journal of the pressure roller.

4. The method of claim 1 wherein the step of measuring the widths of the nip comprises manual measurement of the widths, and the step of storing a plurality of data structures comprising the measured widths of the nip in the memory of the controller of the control system comprises manual entry of the measured widths of the nip into an interface of the machine.

5. The method of claim 1 wherein the step of measuring the widths of the nip comprises measuring the widths of the nip with a vision system.

6. The method of claim 5 wherein the step of storing a plurality of data structures comprising the measured widths of the nip in the memory of the controller of the control system comprises manual entry of the widths of the nip into an interface of the machine.

7. The method of claim 5 wherein the step of storing a plurality of data structures comprising the measured widths of the nip in the memory of the controller of the control system comprises sending data representative of the measured widths of the nip from the vision system to the controller automatically.

8. The method of claim 1 wherein the step of calculating the deflection curvature of the pressure roller comprises calculating a relative deflection between the location near the centerline of the pressure roller and the locations approximately equidistant from the centerline of the pressure roller.

9. The method of claim 1 further comprising calculating the pressure roller cover modulus from the pressure roller cover hardness.

10. The method of claim 1 further comprising changing the widths of the nip based on at least one of (i) surface temperature changes, (ii) speed, (iii) cover modulus changes, (iv) deflection, (v) pressure; and/or (vi) torque, all of which are associated with the pressure roller.

11. The method of claim 1 further comprising storing a plurality of data structures comprising at least one surface temperature of the pressure roller.
